(19) United States
(12) Patent Application Publication
(10) Pub. No.: US 2005/0234591 A1
(43) Pub. Date: Oct. 20, 2005

(54) Method and system for pharmaceutical automation

(76) Inventor: Jun Ho Kim, Daegu (KR)

Correspondence Address: PARK & SUTTON LLP, 3255 WILSHIRE BLVD, SUITE 1110, LOS ANGELES, CA, 90010, US

(21) Appl. No.: 11/153,956

(22) Filed: Jun. 16, 2005

Related U.S. Application Data
(63) Continuation of application No. 10/372,679, filed on Feb. 25, 2003, now abandoned.

(51) Int. Cl. B65B 35/54; G06F 17/00

(52) U.S. Cl. 700/231

(57) ABSTRACT

A pharmaceutical automation method and a system are provided. The method includes steps of randomly mounting a cassette filled with a predetermined type of tablets on a selected one of a plurality of cassette seats of a cassette seat unit, retrieving tablet data stored in a memory of the cassette, updating tablet data in a microcomputer of the selected cassette seat with the retrieved tablet data, communicating with a server and sharing the tablet data with the server by the microcomputer of the selected cassette seat, selectively commanding the microcomputer of one of the plurality of the cassette seats to enable the cassettes to selectively release the tablets in accordance with a prescription input, and packaging in which the released tablets are packed into tablet containing bags.

### RELATED APPLICATION

This application is a continuation application of U.S. patent application Ser. No. 10/372,679, filed Feb. 25, 2003, the disclosure which is incorporated by reference into this disclosure as if fully set forth herein.

### BACKGROUND OF THE INVENTION

The invention relates to a pharmaceutical automation system. More particularly, the present invention relates to an automatic tablet dispensing and packaging system enabling tablet containing cassettes to become randomly mounted on their cartridges which in turn recognize the random cassette mount to thereby prevent the tablet cassettes from being erroneously displaced during the tablet cassette mount.

Conventional automatic tablet dispensing and packaging systems employ manual matching mechanism for tablet cartridges and tablet cassettes mounted on the tablet cartridges. That is, when tablet refill is required, a tablet cassette is removed from the cartridge and remounted on the same cartridge with the cassette refilled with designated tablets. For this purpose, cartridges and tablet cassettes are sequentially numbered in pair so that the refilled cassette can be mounted on the matching cartridge without fail by comparing a number tag of the refilled cassette with the matching cartridge.

Such conventional manual matching mechanism is inevitably subject to an operator's mistake that may occur when the refilled cassette is mounted on a wrong cartridge. Moreover, each tablet refill requires a visual checkup to confirm the match, further burdening the operator and deteriorating reliability of the mechanism.

### SUMMARY OF THE INVENTION

The present invention is contrived to overcome the conventional disadvantages. Accordingly, it is an object of the present invention to provide an pharmaceutical automation system that enables tablet containing cassettes to become randomly mounted on their cartridges or cassette seats which in turn recognize the random cassette mount to thereby prevent the tablet cassettes from being erroneously displaced during the tablet cassette mount.

Another object of the invention is to adopt an automatic matching mechanism controlled by a main computer or server, thereby improving product reliability. A further object is to relieve burden on a system operator or a pharmacist resulting from heavy concentration on the conventional cassette-cartridge matching during tablet refill process.

To achieve these and other objects, the pharmaceutical automation system according to the present invention comprises a server processing a prescription input. A cartridge unit is provided to have a plurality of cartridges, and a microcomputer is installed in each of the cartridges to communicate with the server. A plurality of cassettes are respectively filled with a predetermined type of tablets and detachably mounted on the cartridges. Here, a memory is planted in each of the cassettes to store therein a tablet data specifying the type of tablets in the corresponding cassette.

The respective cassette-to-cartridge mount actuates the microcomputer to read and share with the server the tablet data in the corresponding memory. The server selectively commands the microcomputers to enable the cassettes to selectively release the tablets in accordance with the prescription input, whereby when one of the cassettes is randomly mounted on one of the cartridges the microcomputer of the corresponding cartridge becomes updated to include the tablet data stored in the memory of the corresponding cassette to thereby control the tablet release in accordance with the description input.

Further provided are a packaging unit provided below the cartridge unit to package the released tablets into tablet containing paper bags, a hopper provided below the cartridge unit to guide the released tablets to the packaging unit, and a tray unit provided between the cartridge unit and the hopper. The tray unit has a tray partitioned to releasably hold therein extra types of tablets which are selectively released in accordance with a conveyer belt mechanism activated by the server. The tray is horizontally pulled out from the system to open for spreading therein the extra types of tablets.

The invention also provides a method of pharmaceutical automation. The method includes the steps of randomly mounting a cassette filled with a predetermined type of tablets on a selected one of a plurality of cassette seats of a cassette seat unit, retrieving tablet data stored in a memory of the cassette, updating tablet data in a microcomputer of the selected cassette seat with the retrieved tablet data, communicating with a server and sharing the tablet data with the server, which processes a prescription input, by the microcomputer of the selected cassette seat, selectively commanding the microcomputer of one of the plurality of the cassette seats to enable the cassettes to selectively release the tablets in accordance with the prescription input, and packaging in which the released tablets are packed into tablet containing bags.

Advantages of the present invention are numerous in that: (1) the pharmaceutical automation system enables each tablet containing cassette to become randomly mounted on the corresponding cartridge without worry of erroneous wrong mount, thereby improving efficiency and a user's satisfaction; (2) the automatic matching mechanism between the tablet cassettes and the cartridges is simultaneously administered by the server and the microcomputers in the cartridges, thereby enhancing product reliability; and (3) the pharmaceutical automation system substantially relieves burden on a system operator or a pharmacist resulting from heavy concentration on the conventional cassette-cartridge matching during tablet refill process.

Although the present invention is briefly summarized, the full understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a block diagram showing mechanism of the pharmaceutical automation system according to the present invention;

FIG. 2 is a structural view showing an automatic tablet dispensing and packaging apparatus of the automation system according to the present invention;

FIGS. 3A and 3B are views showing instances of cassette-to-cartridge mounting according to the present invention;

FIG. 4 is a structural view showing the cassette-to-cartridge mounting mechanism according to the present invention; and

FIG. 5 is a flow chart illustrating the pharmaceutical automation method according to the present invention.

### DETAILED DESCRIPTION OF THE PREFERRED EMBODIMENTS

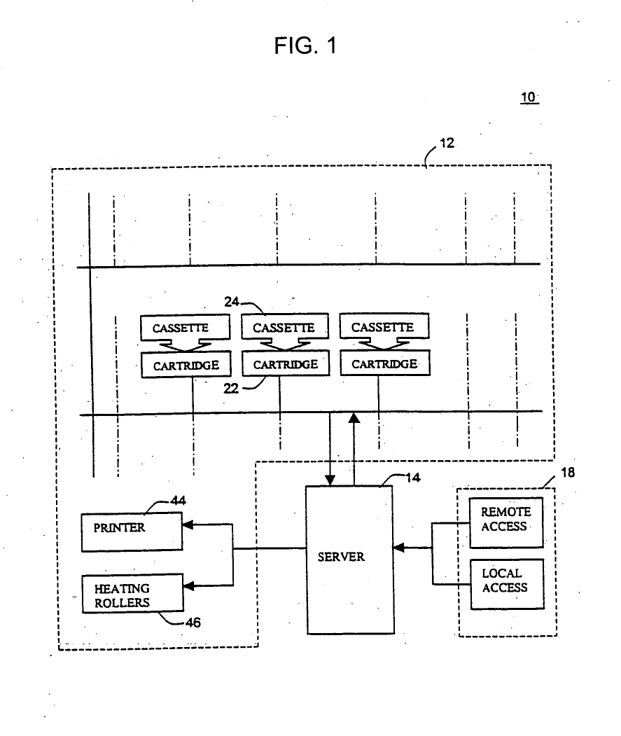

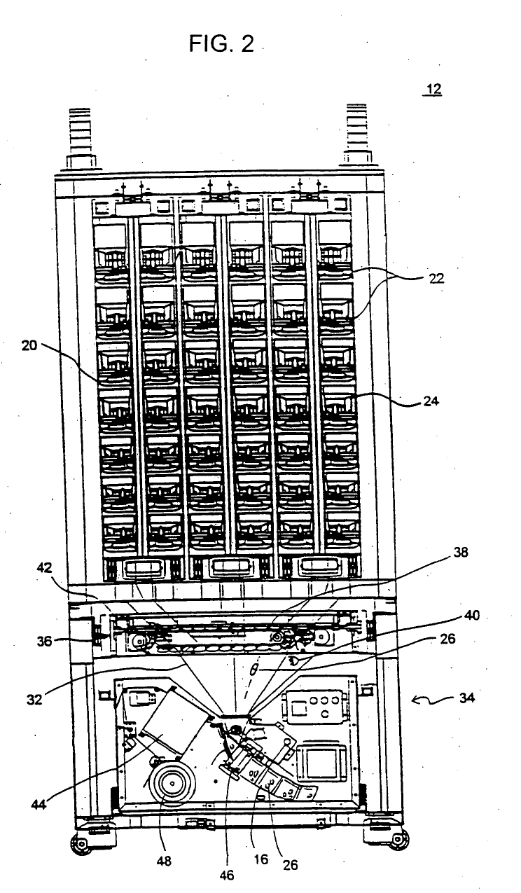

FIG. 1 illustrates an operational mechanism of a pharmaceutical automation system 10 according to the present invention. As shown therein, the pharmaceutical automation system 10 comprises an automatic tablet dispensing and packaging apparatus 12 and a server 14 controlling the apparatus 12. FIG. 2 shows the automatic tablet dispensing and packaging apparatus 12 to process a prescription input into a plurality of tablet containing paper bags 16. The prescription input may be entered by a qualified system operator or a pharmacist into the server 14 via an input device 18 such as a keyboard, a touch screen and a voice activator. The input device is controlled either via a local access, for example, within a drug store, or via a remote access, for example, through the Internet.

The tablet dispensing and packaging apparatus 12 includes a cartridge unit 20 having a plurality of cartridges or cassette seats 22. The cartridges 22 are vertically formed in columns and rows within the apparatus 12. Preferably, the cassette rows are aligned substantially circular. In this construction, a plurality of cassettes 24 are detachably mounted on the cartridges 22.

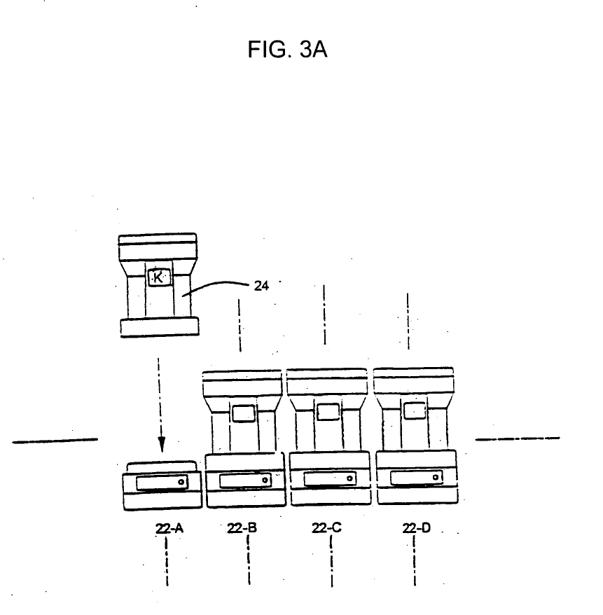

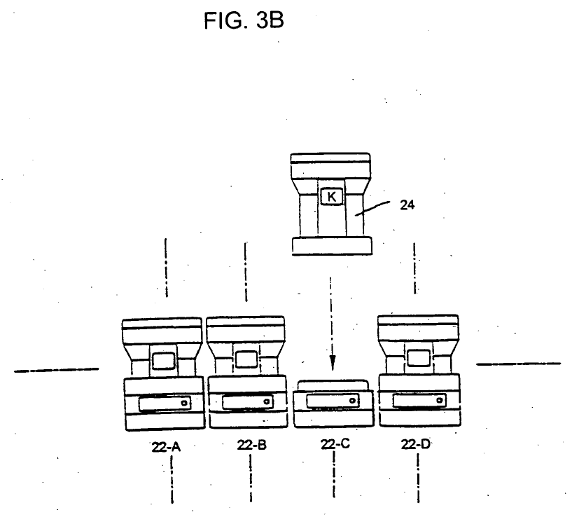

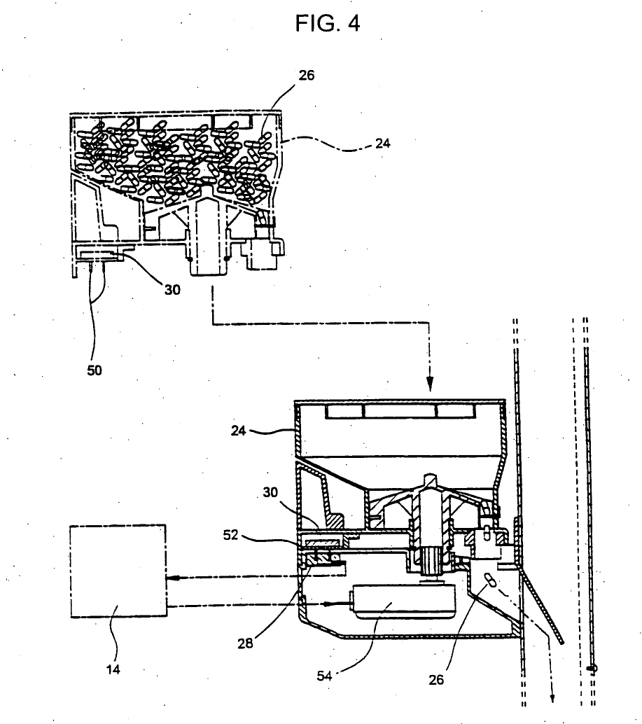

Meanwhile, FIGS. 3A and 3B respectively show instances of cassette-to-cartridge mechanism. As shown therein, the cartridges 22 are aligned without labels showing respective locations whereas cassettes 24 are labeled to discern one from another. In addition to the labeling on each cassette 24, each front of the cassettes 24 may have a barcode printed to carry information of tablets 26 being stored therein so as to facilitate tablet refill processing especially when dealing with a large number of different tablets. That is, the cassettes 24 are labeled either by barcodes or by sequential symbols to respectively associate with the corresponding tablet data.

For a better performance, a microcomputer 28 is installed in each of the cartridges 22 to communicate with the server 14. The plurality of cassettes 24 are respectively filled with a predetermined type of tablets 26 and detachably mounted on the cartridges 22. A memory 30 is planted in each of the cassettes 24 to store therein a tablet data specifying the type of tablets 26 in the corresponding cassette 24. Here, the respective cassette-to-cartridge mount actuates the microcomputer 28 to read and share with the server 14 the tablet data in the corresponding memory 30. In the meantime, the server 14 selectively commands the microcomputers 28 to enable the cassettes 24 to selectively release the tablets 26 in accordance with the prescription input, whereby when one of the cassettes 24 is randomly mounted on one of the cartridges 22 the microcomputer 28 of the corresponding cartridge 22 becomes updated to include the tablet data stored in the memory 30 of the corresponding cassette 24 to thereby control the tablet release in accordance with the description input.

As shown back in FIG. 3A, for example, the randomly aligned four cartridges 22-A, 22-B, 22-C, 22-D become numerated in accordance with the cassette mount. That is, when the cassette 24 labeled K is mounted on the first cartridge 22-A then the cartridge 22-A becomes synchronized with the cassette 24-K so that the tablet information stored in the corresponding memory 30 is read and shared with the server 14, whereby the cassette 24-K is controlled by the cartridge 22-A and the server 14. As further shown back in FIG. 3B, when the cassette 24-K is mounted on the cartridge 22-C, then the microcomputer 28 in the cartridge 22-C reads and shares with the server 14 the cassette information stored in the memory 30 of the cassette 24-K.

A hopper 32 is provided below the cartridge unit to downwardly guide the tablets 26 released from the cassettes 24. A packaging unit 34 is provided below the cartridge unit 20 to package the released tablets 26 into tablet containing paper bags 16.

In a preferred version, a tray unit 36 is provided between the cartridge unit 20 and the hopper 32. The tray unit 36 has a tray 38 partitioned to releasably hold therein extra types of tablets 40. The extra types of tablets 40 are selectively released in accordance with a conveyer belt mechanism 42 activated by the server 14. The tray 38 is horizontally pulled out from the apparatus 12 of the system 10 to open for spreading therein the extra types of tablets 40.

The packaging unit 34 comprises a printer 44 and heating rollers 46. The printer 44 is connected to the server 14 so that tablet dosage instructions are printed by the printer 44 on an unrolled paper 48. The heating rollers 46 are provided to seal the released tablets consecutively captured by the unrolled paper 46 into the tablet containing tablet bags 16.

In order to improve the cassette-to-cartridge mounting mechanism, at least a terminal 50 is formed in each of the cassettes 24 so as to become connected to the memory 30 in the corresponding cassette 22. Also, a socket 52 is provided in each of the cartridges 22 to receive the terminal 50 therein upon the cassette-to-cartridge mount. A motor 54 is also provided in each of the cartridges 22 to activate the tablet release from the cassette 24 mounted on the corresponding cartridge 22. Here, the motor 54 is controlled by the corresponding microcomputer 28 communicating with the server 14.

The server 14 comprises a processor to control the microcomputer 28 in each cartridge 22 in accordance with the prescription input via the input device 18 which can be one selected from a keyboard, a touch screen and a voice activator. The server 14 may be either a local area network computer or an internet-enabled network computer.

As discussed above, an advantage of the present invention is that the pharmaceutical automation system 10 enables each tablet containing cassette 24 to become randomly mounted on the corresponding cartridge 22 without worry of erroneous wrong mount, thereby improving efficiency and a user's satisfaction. Further, the automatic matching mechanism between the tablet cassettes 24 and the cartridges 22 is simultaneously administered by the server 14 and the microcomputers 28 in the cartridges 22, thereby enhancing product reliability. In addition, the pharmaceutical automation system 10 substantially relieves burden on a system operator or a pharmacist resulting from heavy concentration on the conventional cassette-cartridge matching during tablet refill process.

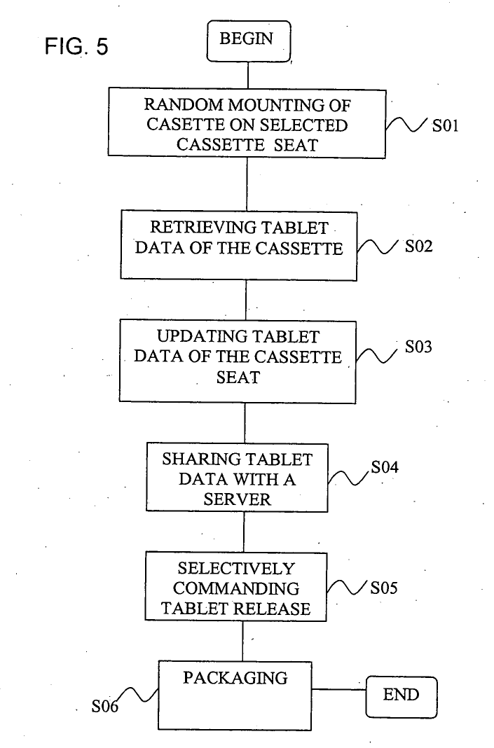

FIG. 5 illustrates a pharmaceutical automation method according to the present invention. In step S01, randomly mounting the cassette 24 filled with a predetermined type of tablets on a selected one of a plurality of the cassette seats 22 of the cassette seat unit 20. This step is repeated for the plurality of the cassettes 24 with various different types of tablets.

In step S02, the tablet data stored in the memory 30 of the cassette 24 is retrieved.

In step S03, the tablet data in the microcomputer 28 of the selected cassette seat 22 is updated with the retrieved tablet data.

In step S04, the microcomputer 28 of the selected cassette seat 22 communicates with the server 14 and shares the tablet data with the server 24.

In step S05, the server 24 selectively commands the microcomputer 28 of one of the plurality of the cassette seats 22 to enable the cassettes 24 to selectively release the tablets in accordance with the prescription input.

In step S06, the released tablets are packed into tablet containing bags.

Although the invention has been described in considerable detail with reference to certain preferred versions thereof, other versions are possible by converting the aforementioned construction. Therefore, the scope of the invention shall not be limited by the specification specified above and the appended claims.

1. A pharmaceutical automation system, comprising:
a) a server processing a prescription input;
b) a cassette seat unit having a plurality of cassette seats aligned in columns and rows, wherein the cassette seats are not seemingly numbered or labeled, wherein a microcomputer is installed in each of the cassette seats to communicate with the server;
c) a plurality of cassettes respectively filled with a predetermined type of tablets, wherein the cassettes each containing a different type of tablets are each detachably mounted on and directly connected to the cassette seats such that each of the cassettes directly abuts on a randomly selected one of the cassette seats, wherein the cassettes are seemingly numbered or labeled to discern one from another, wherein a memory is planted in each of the cassettes to store therein a tablet data specifying the type of tablets in the corresponding cassette, wherein the respective cassette-to-seat mount actuates the microcomputer in the randomly selected cassette seat to read and share with the server the tablet data in the memory in the corresponding cassette, wherein the server selectively commands the microcomputers to enable the cassettes to selectively release the tablets in accordance with the prescription input; and
d) a packaging unit provided below the cassette seat unit to package the released tablets into tablet containing paper bags,
wherein when one of the cassettes is randomly mounted on a selected one of the cassette seats, the microcomputer in the selected cassette seat becomes updated to retrieve the tablet data stored in the memory of the corresponding cassette, whereby a wrongful cassette mounting is systematically prevented while securing the tablet release of the randomly mounted cassette in accordance with the prescription input.

2. The system of claim 1 further comprising a hopper provided below the cassette seat unit to guide the released tablets to the packaging unit.

3. The system of claim 1 further comprising:
a) a terminal in each of the cassette seat, wherein the terminal is connected to the memory in the corresponding cassette;
b) a socket in each of the cassette seats to receive the terminal therein upon the cassette-to-seat mount; and
c) a motor in each of the cassette seats to activate the tablet release from the cassette mounted on the corresponding cassette seat, wherein the motor is controlled by the corresponding microcomputer communicating with the server.

4. The system of claim 1 further comprising:
a) an input device; and
b) a processor in the server to control the microcomputer in said each cassette seat in accordance with the prescription input via the input device.

5. The system of claim 4 wherein the input device is a touch screen.

6. The system of claim 1 wherein the server is a local area network computer.

7. The system of claim 1 wherein the server is an internet-enabled network computer.

8. The system of claim 1 wherein the packaging unit comprises:
a) a printer connected to the server, wherein tablet dosage instructions are printed by the printer on an unrolled paper; and
b) heating rollers to seal the released tablets consecutively captured by the unrolled paper into the tablet containing tablet bags.

9. A pharmaceutical automation system, comprising:
a) a server processing a prescription input;
b) a cassette seat unit having a plurality of cassette seats aligned in columns and rows, wherein the cassette seats are not seemingly numbered or labeled, wherein a microcomputer is installed in each of the cassette seats to communicate with the server;
c) a plurality of cassettes respectively filled with a predetermined type of tablets, wherein the cassettes each containing a different type of tablets are each detachably mounted on and directly connected to the cassette seats such that each of the cassettes directly abuts on a randomly selected one of the cassette seats, wherein the cassettes are seemingly numbered or labeled to discern one from another, wherein a memory is planted in each of the cassettes to store therein a tablet data specifying the type of tablets in the corresponding cassette, wherein the respective cassette-to-seat mount actuates the microcomputer in the randomly selected cassette seat to read and share with the server the tablet data in the memory in the corresponding cassette, wherein the server selectively commands the microcomputers to enable the cassettes to selectively release the tablets in accordance with the prescription input;
d) a hopper provided below the cassette seat unit to downwardly guide the released tablets;
e) a tray unit provided between the cassette seats unit and the hopper, wherein the tray unit has a tray partitioned to releasably hold therein extra types of tablets, wherein the extra types of tablets are selectively released in accordance with a conveyer belt mechanism activated by the server, wherein the tray is horizontally pulled out from the system to open for spreading therein the extra types of tablets; and
f) a packaging unit provided below the cassette seat unit to package the released tablets into tablet containing paper bags,
wherein when one of the cassettes is randomly mounted on a selected one of the cassette seats, the microcomputer in the selected cassette seat becomes updated to retrieve the tablet data stored in the memory of the corresponding cassette, whereby a wrongful cassette mounting is systematically prevented while securing the tablet release of the randomly mounted cassette in accordance with the description input.

10. The system of claim 9 further comprising:
a) a terminal in each of the cassettes, wherein the terminal is connected to the memory in the corresponding cassette;
b) a socket in each of the cassette seats to receive the terminal therein upon the cassette-to-seat mounting; and
c) a motor in each of the cassette seats to activate the tablet release from the cassette mounted on the corresponding cassette seat, wherein the motor is controlled by the corresponding microcomputer communicating with the server.

11. The system of claim 9 further comprising:
a) an input device; and
b) a processor in the server to control the microcomputer in said each cassette seat in accordance with the prescription input via the input device.

12. The system of claim 11 wherein the input device is a touch screen.

13. The system of claim 11 wherein the input device is voice-activated.

14. The system of claim 9 wherein the server is a local area network computer.

15. The system of claim 9 wherein the server is an internet-enabled network computer.

16. The system of claim 9 wherein the packaging unit comprises:
a) a printer connected to the server, wherein tablet dosage instructions are printed by the printer on an unrolled paper; and
b) heating rollers to seal the released tablets consecutively captured by the unrolled paper into the tablet containing tablet bags.

17. The system of claim 9 wherein the plurality of cassettes are vertically aligned in columns and rows, wherein the cassette rows are substantially circular.

18. The system of claim 9 wherein the cassettes are labeled either by barcodes or by sequential symbols to respectively associate with the corresponding tablet data.

19. A pharmaceutical automation method, comprising the steps of:
a) randomly mounting a cassette on a selected one of a plurality of cassette seats of a cassette seat unit, wherein the cassette is filled with a predetermined type of tablets;
b) retrieving tablet data stored in a memory of the cassette;
c) updating tablet data in a microcomputer of the selected cassette seat with the retrieved tablet data;
d) communicating with a server and sharing the tablet data with the server by the microcomputer of the selected cassette seat, wherein the server processes a prescription input; and
e) selectively commanding the microcomputer of one of the plurality of the cassette seats by the server to enable the cassettes to selectively release the tablets in accordance with the prescription input.

20. The method of claim 19, further comprising a step of packaging in which the released tablets are packed into tablet containing bags.
